(19) United States
(12) Patent Application Publication
(10) Pub. No.: US 2023/0222403 A1
(43) Pub. Date: Jul. 13, 2023

(54) COMMUNICATIONS SERVER APPARATUS AND METHOD FOR ALLOCATING RESOURCES TO SERVICE REQUESTS RELATED TO A SHARED ECONOMY ON-DEMAND SERVICE OR ASSET PROVISION

(71) Applicant: GRABTAXI HOLDINGS PTE. LTD., Singapore (SG)

(72) Inventors: Junpeng NIU, Singapore (SG); Hendra Teja WIRAWAN, Singapore (SG); Mayank SANCHETI, Singapore (SG)

(21) Appl. No.: 18/009,622

(22) PCT Filed: Sep. 29, 2021
(86) PCT No.: PCT/SG2021/050586

§ 371 Date: Dec. 9, 2022

(30) Foreign Application Priority Data
Oct. 1, 2020 (SG) 10202009755U

(51) Int. Cl. G06Q 10/0631; G06Q 10/083

(52) U.S. Cl. CPC G06Q 10/0631; G06Q 10/083

(57) ABSTRACT

A communications server apparatus, and associated method, for allocating resources to service requests related to a shared economy on demand service or asset provision, the communications server apparatus comprising a processor and a memory, and being configured, under the control of the processor, to execute instructions stored in the memory to receive a plurality of service requests, each service request comprising data representative of a service or asset requested and a delivery time at or by which said service or asset is required; determine, in respect of each said service request, a lead time comprising a time period between a time at which a respective service request is received and the associated delivery time; compare each said lead time with a predetermined threshold, and define each respective lead time as high if it is greater than the predetermined threshold and low if it is less than the predetermined threshold; receive resource data comprising data representative of available resources capable of providing said service or asset; generate cost matrix data, each element of said cost matrix being representative of an available resource-service request pair, said cost matrix data assigning, in respect of each available resource-service request pair, a cost value; wherein assigning cost values comprises calculating, for each available resource-service request pair, a cost value, dependent on whether the lead time associated with the respective service request is high or low; and, for each service request, select, from a respective set of available resource-service request pair cost values, a minimum cost value and assign the available resource associated with the selected cost value to the respective service request.

### TECHNICAL FIELD

The invention relates generally to the field of communications. One aspect of the invention relates to a communications server apparatus for allocating resources to service requests in a shared economy on-demand service or asset provision. Another aspect of the invention relates to a method, performed in a communications server for allocating resources to service requests in a shared economy on-demand service or asset provision. Another aspect of the invention relates to a computer program product comprising instructions therefor. Another aspect of the invention relates to a computer program comprising instructions therefor. Another aspect of the invention relates to a non-transitory storage medium storing instructions therefor. Another aspect of the invention relates to a communications system for allocating resources to service requests in a shared economy on-demand service or asset provision.

One aspect of the invention has particular, but not necessarily exclusive, application in a food (or other product) delivery service.

### BACKGROUND

Currently, allocating resources to on-demand services, such as food delivery services, is based typically on driver availability and estimated travel times to the merchant premises and then to the customer. These signals enable available drivers to be assigned to food order deliveries as merchant requests are received, based on available drivers within the correct geographical region. For example, some systems, when a merchant request is received, may simply allocate the nearest available driver. The allocated driver is then flagged as ‘busy’ (and, therefore, not available for allocation to any other merchant requests) until the food order has been delivered. The driver may then be allocated to another merchant request if or when they are deemed the nearest available driver thereto. Of course, this can and does lead to driver idle times, which represents an inefficient use of available resources. In addition, especially during busy periods when large numbers of merchant requests are being received, since drivers are not able to be allocated to a merchant request until their last delivery is completed, there can be a severe shortage of available drivers in relation to the number of unmet merchant requests, leading to delays in delivery. This, in turn, can lead to deterioration (i.e. cooling) of food, and customer/merchant dissatisfaction. This extreme supply-demand imbalance can quickly lead to a saturation point, where the backlog of merchant requests in relation to available drivers means that no more merchant requests can be served in an acceptable time frame. Of course, such a mismatch in the supply-demand distributions is not limited to food (or other on-demand, shared economy) delivery services, but can be equally applicable to other shared economy services, such as Cloud computing and peer-to-peer electricity trading, for example.

Attempts have been made to address this supply-demand imbalance by providing, within the system, the facility whereby a driver (resource) serving a first merchant request can be ‘assigned’ to a second merchant request with a much longer lead time. The system then waits to dispatch the driver to serve the second merchant request so that they arrive to collect the food just in time, i.e. at a time estimated (by the merchant) by which the preparation of the food is expected to be completed. However, this does not really solve the problem of the supply-demand imbalance, and the peaks and troughs in the supply-demand distribution during busier and quieter times, because the driver remains flagged as ‘busy’ (and not available to be allocated to further merchant requests) until the second merchant request is, at least, in the process of being served.

United States Patent Publication No. 20040210621 describes a method and system for order optimisation, wherein an optimisation algorithm is used to select available drivers (including those in-transit completing another order) in a way that minimises customer wait time, which is calculated using a sum of parameters comprising an estimated time for the driver to reach the merchant's premises, an estimated wait time, and estimated time to reach the customer and some fixed estimates of additional time taken to complete a delivery (getting in and out of the vehicle, taking payment and physically making the delivery, etc.). However, this model is concerned with customer wait times only, i.e. optimising customer satisfaction by minimising wait times; it does not really contribute at all to addressing the supply-demand imbalance or consider proper smooth utilisation of driver resources, and this would be particularly true in the far more complex shared economy applications, where an ‘independent’ driver may simply ignore or decline a service request if, for example, it would take them to a remote end (customer) location from which their return journey time to a more central, urban location would preclude them from being allocated further service requests until they have travelled a significant distance back to a location where service requests are likely to originate and, as a result, leave them idle for a period of time and/or in the wrong place to efficiently serve the next service request. This model can also result in driver under-utilisation (or an inefficient use of available resources) in that a driver may be allocated a service request (because, by serving that request, it has been determined that the lowest possible customer wait time is achievable), but the driver may have to wait at the merchant's premises for the food to be prepared, especially if the food preparation time is longer than allowed by the model in estimating the time at which the food will be ready for delivery. Conversely, if the food preparation time happens to be shorter than allowed, it may be ready before the driver arrives, which may, in turn, result in the food cooling before it has been delivered, causing customer dissatisfaction.

All of these issues lead to difficulties in driver resource allocation and may exacerbate mismatches in supply and demand characteristics, and an inefficient use or under-utilisation of available resources. Furthermore, the method and system described in US20040210621 is not scalable to take into account an unknown, potentially very large, number of available drivers at any one time, within several different regions, and all having the ability to switch from available to not available at will in a shared economy system. Instead, it tends to rely on the overall driver resource being a finite and known quantity within a single defined region, with only their availability being variable, and even that being based on whether or not they are already allocated to a job, and how long it might be before they have completed it. In contrast, particularly in a shared economy system, new drivers can become available at any unscheduled time and in any region, and, equally, drivers can make themselves unavailable at any time. Still further, and as mentioned above, drivers in a shared economy system are not required to accept any job, and can either ignore or refuse a job at will. Known systems do not adequately compensate for these issues, which can contribute further to the above-mentioned mismatch in supply and demand characteristics.

### SUMMARY

Aspects of the invention are as set out in the independent claims. Some optional features are set out in the dependent claims.

Implementation of the techniques disclosed herein may have significant technical advantages. A component that is presently not incorporated into the allocation of resources in a shared economy on-demand model, such as a food delivery service, is the allocation of resources according to a cost that is calculated to take into account a highly variable parameter, such as food preparation time (or, more generally, a ‘lead time’). In the known techniques, a high demand results in a comparatively much higher supply cost as a result of wastage or redundancy within the resource supply pool. The techniques disclosed herein may accommodate other, often highly variable parameters, such as food preparation time, within the available resource allocation model. Accordingly, resource allocation may be performed so as to reduce redundancy and utilise the available resource supply pool to a greater extent, without reducing the quality of service provided to the service request originator or the end user. As such, an overall improvement in resource utilisation may be provided.

For each service request, for example a food delivery order request, a set of cost calculations may be performed in respect of all available supply resources, in this example, drivers, including those that are currently in-transit servicing another service request. A supply resource having a minimum calculated cost value may then be selected to service the current service request. The method for calculating the cost value in respect of each available resource may be variable, depending on the value of one or more of the variable parameters incorporated into the calculation. For example, the method of calculating a cost to be assigned to a resource in respect of a service request may be different for cases where a variable is above or below a predetermined threshold defining that variable as ‘high’ or ‘low’ respectively. This variable may be directly or indirectly linked to the quality of service (e.g. customer waiting time). By varying the cost calculation based on the value of one or more of the highly variable parameters, a greater degree of granularity is achieved, and the cost calculations can thus take into account more of the variable parameters, which may enable less resources to service more service requests than in known systems, or the same resource supply pool to service more service requests within a given period of time than in known systems, without loss of quality of service and, indeed, in many cases, with an improved quality of service because resources can be allocated to service requests more quickly and, as such the service requests can be dispatched more efficiently than in known systems. By using a threshold to define two distinct ‘types’ of the variable parameter, account can be taken of the parameter value within the costs calculations, without undue burden on the processing overhead required to implement the technique.

In an implementation of a shared economy food delivery service, the resource pool may comprise available drivers in a specified geographical region within which a service request, i.e. a food delivery order, may originate and or will be fulfilled. This may include drivers that are currently in-transit fulfilling a previous service request, as well as ‘idle’ drivers who are not currently fulfilling a service request. The above-mentioned variable parameter may comprise food preparation time, wherein this parameter is defined as ‘high’ if it is above a predefined threshold and ‘low’ if it is below the predefined threshold. A cost may be assigned to plurality of order-driver pairs that is calculated by a method (or equation) dictated by whether the food preparation time is deemed to be ‘high’ or ‘low’. Other estimated quantities, such as estimated travel time for a specified driver to arrive at the food merchant premises and an estimated waiting time at the merchant location based on the food preparation time in relation to the above-mentioned travel time may also be included to further improve the accuracy of this cost calculation. The calculations may also include a weighting parameter that is, once again, different, depending on whether the food preparation time is defined as ‘high’ or ‘low’. Therefore, the resultant cost values assigned to each available resource may take into account the food preparation time, and be highly responsive to such a critical parameter without undue processing burden. In at least some implementations, the method ensures that all potentially available resources are considered during the resource allocation process so as to enable service request originator (e.g. end customer) satisfaction to be improved by minimising waiting times for service delivery. In this regard, in an implementation, the resource having the lowest assigned cost may be allocated to a specified service request.

Thus, the resource network utilisation can be improved using some of the techniques described herein. For example, in an implementation, more service requests can be delivered during a period of time than would be the case in known systems using the same number of available resources within a specified geographical region or pool, and with a reduced lag time, thereby providing a potential improvement in supply-demand balancing. As such, to avoid or at least mitigate issues associated with extreme discrepancies in supply-demand imbalance and potentially reducing both lag times (e.g. customer waiting times) and idle times (i.e. periods of time when an available resource is not being utilised or allocated to a service request) which are also technical effects applicable to, for example, electrical supply-load balancing or computer processing load balancing. However, it may be especially useful in systems, such as shared economy delivery systems, where at least some of the variables are also dependent on human behaviour.

In at least some implementations, the cost allocation process for assigning a cost value to each available driver in respect of a specified service request may be performed using an optimisation algorithm such as the Kuhn-Munkres algorithm or other algorithm for solving a linear assignment problem, which may provide the additional advantage of ensuring that the method and system are highly scalable to accommodate a shared economy system having any number of available resources (that may become available and then not available in a substantially uncontrolled manner) and any number of service request originators (e.g. food merchants) within each of a number of different geographical regions which will likely have differing supply-demand distributions.

In one exemplary arrangement, there is provided a communications server apparatus for allocating resources to service requests related to a shared economy on-demand service or asset provision, the communications server apparatus comprising a processor and a memory, and being configured, under the control of the processor, to execute instructions stored in the memory to:

receive a plurality of service requests, each service request comprising data representative of a service or asset requested and a delivery time at or by which said service or asset is required;

determine, in respect of each said service request, a lead time comprising a time period between a time at which a respective service request is received and the associated delivery time;

compare each said lead time with a predetermined threshold, and define each respective lead time as high if it is greater than the predetermined threshold and low if it is less than the predetermined threshold;

receive resource data comprising data representative of available resources capable of providing said service or asset;

generate cost matrix data, each element of said cost matrix being representative of an available resource-service request pair, said cost matrix data assigning, in respect of each available resource-service request pair, a cost value; wherein assigning cost values comprises calculating, for each available resource-service request pair, a cost value, dependent on whether the lead time associated with the respective service request is high or low; and

for each service request, select, from a respective set of available resource-service request pair cost values, a minimum cost value and assign the available resource associated with the selected cost value to the respective service request.

### BRIEF DESCRIPTION OF THE DRAWINGS

The invention will now be described by way of example only, and with reference to the accompanying drawings in which:

FIG. 1 is a schematic block diagram illustrating an exemplary communications system including a communications server apparatus for allocating resources to service requests related to a shared economy on-demand service;

FIG. 2 is a schematic block diagram illustrating an exemplary communications system including an exemplary communications server apparatus for allocating resources to service requests related to a shared economy on-demand service;

FIG. 3 is a schematic process diagram illustrating an exemplary method for allocating resources to service requests related to a shared economy service in the form of a food delivery service; and

FIG. 4 is a schematic illustration of an order-driver cost matrix, stored in a database, for use in allocating orders to drivers related to a food (or other) delivery service.

### DETAILED DESCRIPTION

The techniques described herein are described primarily with reference to use in food (or other perishable or time-sensitive goods) delivery services, but it will be appreciated that these techniques may have a broader reach and cover other types of shared economy services wherein there is at least one unpredictable and highly variable parameter associated with each service request, and in some cases where there may be a need to take into account historical resource behaviour or reliability, when determining a cost associated with a set of available resources in respect of a specified service request.

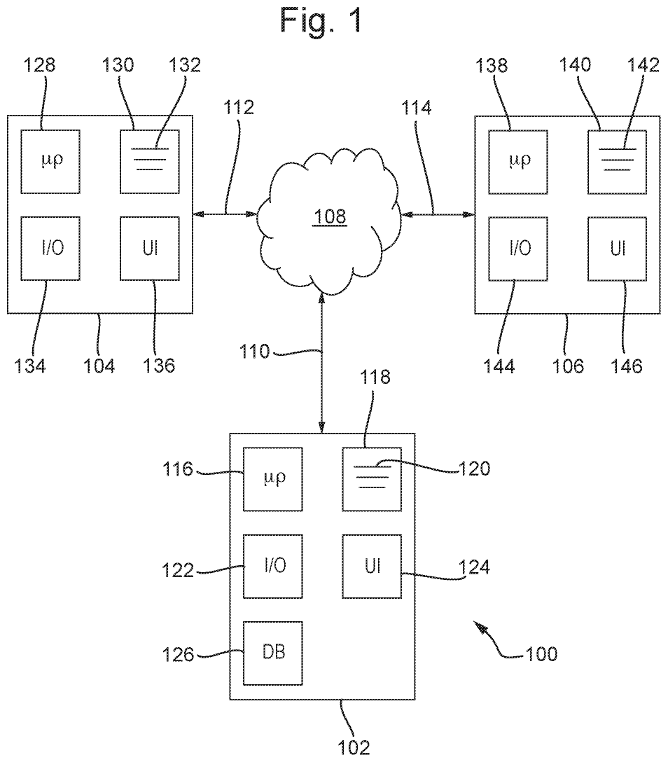

Referring first to FIG. 1, a communications system 100 is illustrated. Communications system 100 comprises communications server apparatus 102, user communications device 104 and service provider communications device 106. These devices are connected in the communications network 108 (for example the Internet) through respective communications links 110, 112, 114 implementing, for example, internet communications protocols. Communications devices 104, 106 may be able to communicate through other communications networks, such as public switched telephone networks (PSTN networks), including mobile cellular communications networks, but these are omitted from FIG. 1 for the sake of clarity.

Communications server apparatus 102 may be a single server as illustrated schematically in FIG. 1, or have the functionality performed by the server apparatus 102 distributed across multiple server components. In the example of FIG. 1, communications server apparatus 102 may comprise a number of individual components including, but not limited to, one or more microprocessors 116, a memory 118 (e.g. a volatile memory such as a RAM) for the loading of executable instructions 120, the executable instructions defining the functionality the server apparatus 102 carries out under control of the processor 116. Communications server apparatus 102 also comprises an input/output module 122 allowing the server to communicate over the communications network 108. User interface 124 is provided for user control and may comprise, for example, computing peripheral devices such as display monitors, computer keyboards and the like. Communications server apparatus 102 also comprises a database 126, the purpose of which will become readily apparent from the following discussion. In this embodiment, database 126 is part of the communications server apparatus 102, however, it should be appreciated that database 126 can be separated from communications server apparatus 102 and database 126 may be connected to the communications server apparatus 102 via communications network 108 or via another communications link (not shown).

User communications device 104 may comprise a number of individual components including, but not limited to, one or more microprocessors 128, a memory 130 (e.g. a volatile memory such as a RAM) for the loading of executable instructions 132, the executable instructions defining the functionality the user communications device 104 carries out under control of the processor 128. User communications device 104 also comprises an input/output module 134 allowing the user communications device 104 to communicate over the communications network 108. User interface 136 is provided for user control. If the user communications device 104 is, say, a smart phone or tablet device, the user interface 136 will have a touch panel display as is prevalent in many smart phone and other handheld devices. Alternatively, if the user communications device is, say, a desktop or laptop computer, the user interface may have, for example, computing peripheral devices such as display monitors, computer keyboards and the like.

Service provider communications device 106 may be, for example, a smart phone or tablet device with the same or a similar hardware architecture to that of user communications device 104. Service provider communications device 106 may comprise a number of individual components including, but not limited to, one or more microprocessors 138, a memory 140 (e.g. a volatile memory such as a RAM) for the loading of executable instructions 142, the executable instructions defining the functionality the service provider communications device 106 carries out under control of the processor 138. Service provider communications device 106 also comprises an input/output module (which may be or include a transmitter module/receiver module) 144 allowing the service provider communications device 106 to communicate over the communications network 108. User interface 146 is provided for user control. If the service provider communications device 106 is, say, a smart phone or tablet device, the user interface 146 will have a touch panel display as is prevalent in many smart phone and other handheld devices. Alternatively, if the user communications device is, say, a desktop or laptop computer, the user interface may have, for example, computing peripheral devices such as display monitors, computer keyboards and the like.

In one embodiment, the service provider communications device 106 is configured to push data representative of the service provider (e.g. service provider identity, location and so on) regularly to the communications server apparatus 102 over communications network 108. In another, the communications server apparatus 102 polls the service provider communications device 106 for information. In either case, the data from the service provider communications device 106 (also referred to herein as ‘available data’ or ‘supply’ data) are communicated to the communications server apparatus 102 and at least some parameters or characteristics thereof stored in relevant locations in the database 126 as historical data. Such supply data stored in the database 126 may be used to generate historical resource availability and reliability data that could include any one or more of, numbers of available service providers in a particular area or region, times of day associated with the service provider availability, service provider ‘ignore’ or ‘reject’ rate (resource reliability data), and even idle times associated with available service providers, so that supply distribution data can be generated and used to predict likely available resources for a particular region, depending on characteristics such as day of the week, time of day, season, etc.

In one embodiment, the user communications device 104 is configured to push data representative of the user (e.g. merchant identity, location, food preparation times or required pick-up times, customer details, and so on) regularly to the communications server apparatus 102 over communications network 108. In another, the communications server apparatus 102 polls the service provider communications device 104 for information. In either case, the data from the user communications device 104 (also referred to herein as ‘service requests’) are communicated to the communications server apparatus 102 and at least some parameters or characteristics thereof stored in relevant locations in the database 126 as historical data, such that demand distribution data can be generated and used to predict likely demand for a particular region, depending on characteristics such as day of the week, time of day, season, etc. As described above, in known shared economy services, such as food delivery services, for example, the nearest available or ‘idle’ resource, e.g. driver, tends to be allocated to a service request, irrespective of any other parameters or characteristics associated with that service request. As a result, there can be a significant under-utilisation of resources. For example, in a known food delivery service of this type, drivers often have to wait at the food merchant premises whilst the food preparation is still underway, and represents further ‘idle’ time which is a waste of the available resources, that could otherwise be utilised to fulfil other service requests. Moreover, the early arrival of drivers results in unnecessary occupation of the merchant's waiting/parking areas to the extent that some merchants may even have to temporarily halt their delivery service availability during peak periods, in order to manage the number of drivers waiting at their premises. Even in solutions that allow the allocation of in-use resources, e.g. in-transit drivers, to further service requests and then only apply (e.g. dispatch) them to the further service requests just in time to commence their fulfilment, i.e., in this example, pick up the orders, those resources remain allocated to those service requests for the intervening period of time between completing the last service request and starting the next one, i.e. they remain unavailable for allocation to other service requests for that period of time, which again represents a waste of (otherwise) available resources, and does not increase the number of service requests that can be fulfilled by the available supply pool at any one time. This is especially wasteful where the lead time is relatively long. In some shared economy type services, the above-mentioned intervening time can be highly variable between service requests, and therefore has a highly variable effect on resource under utilisation. Another drawback of this approach, especially in the food delivery service example described, is a high risk of late delivery if, after delaying the dispatch of the driver to pick up the order, they then decide to reject the job. In other words, no account is taken of historical resource behaviour or reliability during resource allocation in respect of a specified service request, which may be particularly pertinent in a shared economy type service.

Implementations of the techniques disclosed herein seek to address at least some of these issues by utilising a logic processing method that enables resource allocation to be performed which additionally takes account of a highly variable parameter, such as a ‘lead time’, associated with each service request. In a food delivery service, this lead time might comprise the food preparation time or, more accurately, the remaining period of time between the time at which a service request is received and the pick-up time provided by the merchant in the service request. More generally, the ‘lead time’ can be defined as the time between receipt by the communications server apparatus 102 of a service request from the service provider communications device 106 and the time (provided in the service request) at which the resource is required to be available to commence fulfilment of the service request. This lead time can be largely unpredictable prior to receipt of a respective service request and it can be highly variable between service requests, even those from the same service request originator. However, and irrespective of the nature of the shared economy service, the larger this lead time is, the greater its potential adverse effect on the effective utilisation of available resources.

Although the lead time could, in theory at least, be incorporated into each ‘cost’ calculation for each available resource in respect of each service request, the processing overhead and time that this would require makes it prohibitive in a system required to operate in (near) real-time, such as a food (or other type of on-demand) delivery service. Therefore, instead, the logic processing method referred to above acts to distinguish between ‘high’ and ‘low’ lead times, defined by whether a particular lead time is greater or less than a predefined threshold.

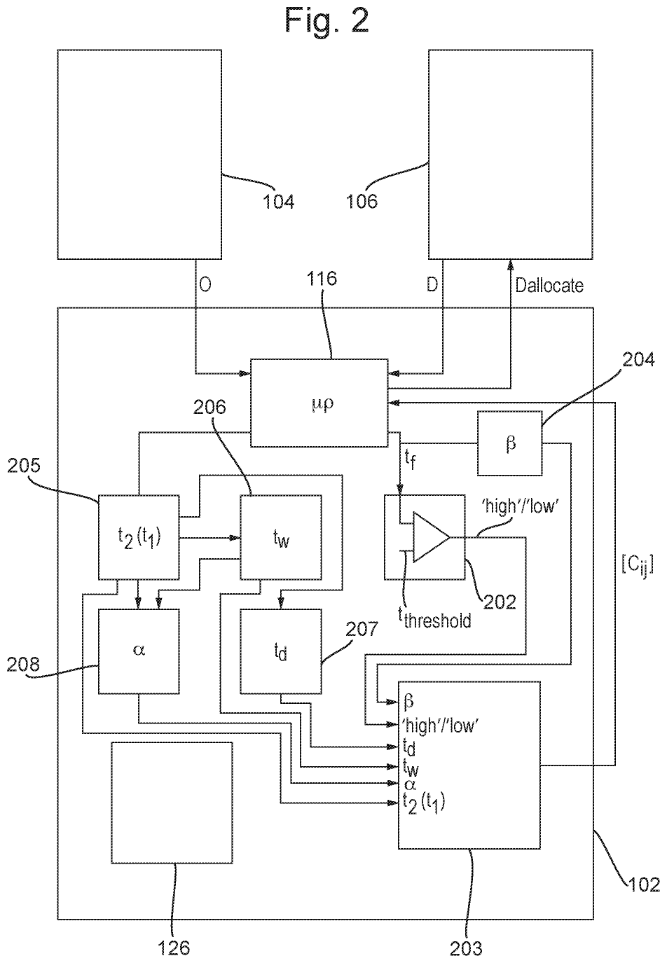

Referring to FIG. 2 of the drawings, in an implementation, the communications system is configured to operate in a shared economy food delivery service. The communications server apparatus 102 is configured to receive service request data in the form of food delivery orders, O, from the service provider (merchant) communications device 106 and resource (i.e. driver) data, D, from the service provider (driver) communications device 104. The food delivery order data and the driver data may be stored in the database 126. Each item of food delivery order data comprises (at least) data representative of the merchant (for example, identity, location, and so on), data representative of the customer (for example, name, address, etc.) and data representative of a time at which the order will be ready to be collected for delivery. Each item of driver data will include (at least) data representative of the identity of the driver, their location and current status (idle/in-transit). The database 126 may also store data representative of the time/date associated with each item of food delivery order data and each item of driver data to enable the above-referenced demand and supply distribution data to be generated. It will be appreciated that various elements of the communications server apparatus 102, the user communications device 104 and the service provider communications device 106 are omitted from FIG. 2 to aid clarity.

The communications server apparatus 102 comprises a comparator 202 that is configured to receive data representative of a (remaining) food preparation time t_{f} based on the time given by the merchant (in the respective food delivery order data) for when the order will be ready for collection and extracted from the food delivery order data. This “lead time” t_{f} is calculated by a microprocessor 116 as being the time period between the current time and the collection time provided by the merchant. The comparator 102 compares the value for t_{f} with a predetermined threshold t_{threshold}. The threshold t_{threshold} can be defined, for example, using the median value of the time taken for a driver to reach a merchant location, and can be updated accordingly based on this statistical value. However, other methods of deriving a threshold time for this purpose will be apparent to a person skilled in the art, and the invention is not necessarily intended to be limited in this regard.

If t_{f} is greater than t_{threshold}, the comparator 202 outputs data indicating that t_{f} is ‘high’. If t_{f} is less than or equal to t_{threshold}, the comparator outputs data indicating that t_{f} is ‘low’. The ‘high’/‘low’ indicator data is provided to a cost calculation processor 203.

The value for t_{f} is also applied to a first weight (13) calculator 204, which calculates a value for a first weight, β, wherein

$$β = \frac{{t}_{f}}{{t}_{threshold}} .$$

The first weight, β, is used in the cost calculation processor 203 to try to avoid the late arrival of drivers to the merchants' premises, i.e. a period of time after the food has been prepared, because such late arrival will increase the overall customer waiting time and may also affect the quality of the food at the time of delivery, thereby adversely impacting the overall customer experience. If t_{f} is high, β is high to avoid delay, whereas if t_{f} is low, β is lower to ensure that a resource can still be allocated to an order even if there is no current available driver that can reach the merchant's premises before the food preparation time has elapsed.

Referring back to FIG. 2 of the drawings, the communications server apparatus 102 also comprises a routing engine 205, that is configured to receive (at least) merchant location data extracted from the food delivery order data received from the user communications device 104, and also driver data from the service provider communications device 106. The driver data will include, for each driver, (at least) current location, current status (idle or in-transit) and, if in transit, location of drop-off point for current order. Using this driver data, the routing engine 205 is configured to calculate, for each driver and at the point in time when a new food delivery order is received, an estimated first time value t₂ which is the estimated travel time from current location (idle status) or drop-off point (in-transit status) to the merchant location. The routing engine 205 is also configured to calculate, for each in-transit driver, an estimated second time value t₁ which is the estimated travel time from their current location to the drop-off point for the previous order. These estimated travel times t₁, t₂ can be estimated using any known techniques, such as those used in satellite navigation systems and the like.

The values t₂ (and, where applicable, t₁) for each driver are fed to the cost calculation processor 203. The values (t₁ and) t₂ for each driver are also fed to first and second time calculation processes 206, 207. In a first calculation process 206, a value t_{d} can be calculated to represent an estimated food collection delay in the case where the driver will reach the merchant after the food has been prepared, wherein t_{d}=max(0, t₁+t₂−t_{f}).

In a second calculation process 207, a value t_{w} can be calculated to represent an estimated driver waiting time in the case where the driver will reach the merchant before the food preparation has been completed, wherein t_{w}=max(0,t_{f}−t₁−t₂).

The values for t_{d} and t_{w} for each driver are fed to the cost calculation processor 203. A second weight, a, calculator 208 is configured to receive data representative of (t₁ and) t₂ and also t_{w} and is configured to calculate a second weight α. When cancelling an order, a driver will state their reason for cancellation, and this data enables the second weight α to be calculated. The second weight α is used in the resource allocation method described hereinafter to control the importance of t₂ over t_{w}. One way to define a is by using the ratio between “driver cancellation rate due to long distance” (high t₂) and “driver cancellation rate due to long waiting time at restaurant” (high t_{w}) with the input data for this calculation coming from the above-referenced reasons for cancellation received from the drivers, and a can also be updated as required, based on this ratio value. The second weight α can be used in the resource allocation method described hereinafter to control the importance of waiting time during allocation. For example, in a shared economy food delivery service, a driver's historical cancellation and ignore behaviour can be utilised to determine whether they prefer long traveling times or long waiting times in merchants in a city, and the weights associated with those drivers can be set or adjusted accordingly. Furthermore, in some cities, merchants prefer drivers not to wait inside/surrounding their places, and the weight can be set and adjusted in relation to service requests from specific merchants to accommodate these requirements.

The cost calculation processor 203 is configured to calculate a cost value cᵢⱼ for each order-driver pair and populate a cost matrix [Cᵢⱼ] accordingly. The cost matrix [Cᵢⱼ] is fed back to the microprocessor 116, which is configured to allocate orders to drivers based on the cost matrix data, as described in more detail below, and transmit dispatch data D_{allocate} to the service provider communications device(s) 106 of driver(s) to provide them with the food delivery order data and enable them to proceed and service the delivery.

In order to aid clarity, FIG. 2 illustrates the comparator 202, the cost calculation processor 203, the routing engine 205 and the process modules 204, 206, 207 and 208 for calculating β, t_{w}, t_{d} and a respectively as physically separate modules. However, all of those processes or modules may be facilitated by a single processing component 116 or by multiple distributed processing components configured to facilitate the functional modules illustrated in FIG. 2 of the drawings, and the present invention is not necessarily intended to be limited in this regard.

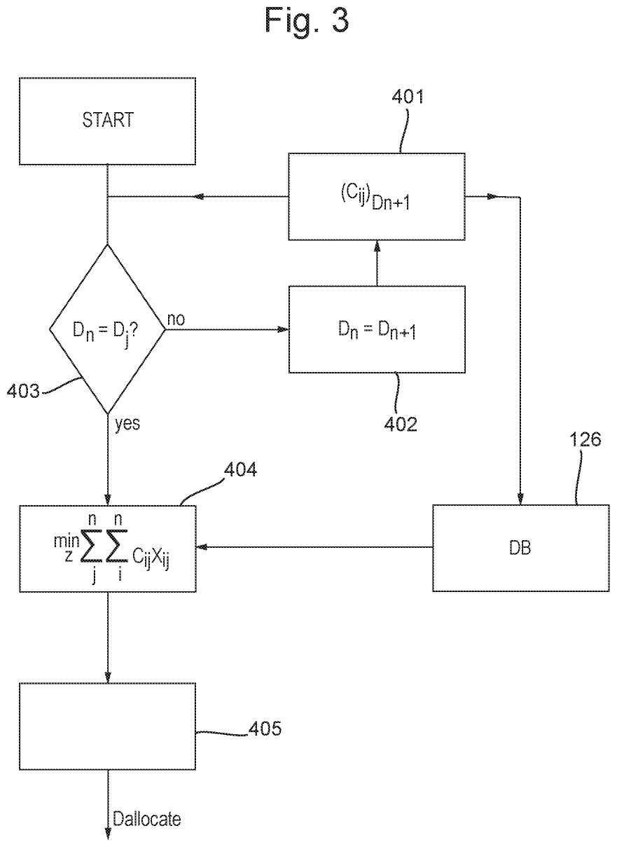

Referring additionally to FIG. 3 of the drawings, a resource allocation method will now be described in more detail. As explained above, in an implementation, a cost calculation processor may be used to facilitate the resource allocation method. The cost calculation processor is configured, in respect of each order o, to receive the inputs t₁, t₂, t_{w} and t_{d} calculated for each available driver d. The cost calculation processor 203 is also configured to receive data representative of whether the food preparation time t_{f} is deemed to be ‘high’ or ‘low’. The weight values α and β may be stored or received by the cost calculation processor 203, depending on whether they are re-calculated and updated for each order, or whether a fixed value is used for each unless and until it is updated (either periodically or when there is a change of conditions and, optionally, based on the historical demand and supply distributions stored in the database 126).

The cost calculation processor is configured to utilise allocation and prioritisation logic to allocate resources based on costs, taking into account the various variables and parameters discussed above. An implementation of the allocation and prioritisation logic is described in more detail below.

Allocation & Prioritisation Logic:

The problem of allocating orders to drivers (or vice versa) is formulated as a general assignment problem as follows, which may be solved by any known assignment algorithm such as, for example, the Kuhn-Munkres algorithm:
Given an n×n cost matrix [cᵢⱼ], to assign each row (order) to a different column (driver) in such a way that the sum of the selected costs is minimum, i.e.:

$${min}_{x} {\sum }_{j}^{n} {\sum }_{i}^{n} {c}_{ij} {x}_{ij}$$

$$s . t . {\sum }_{j}^{n} {x}_{ij} = 1 , for i = 1 , … , n ,$$

$${\sum }_{i}^{n} {x}_{ij} = 1 , for j = 1 , … , n ,$$

$${x}_{ij} ∈ \{ 0 , 1 \} .$$

$${x}_{ij} = 1 , if order i is allocated to driver j$$

$$= 0 , otherwise$$

If the number of orders o is not equal to the number of drivers d, we the cost matrix [cᵢⱼ] can be extended to be a square matrix by adding large numbers into rows or columns.

The cost calculation for each order-driver pair is based on:

cᵢⱼ=t₂+αt_{w}+βt_{d}, if t_{f}>t_{threshold}

cᵢⱼ=t₁+t₂+αt_{w}, If t_{f}<t_{threshold}

The notations inside the formula are as follows:
t₂: estimated time spent from current driver location (idle driver)/previous order drop-off location (in-transit driver) to merchant location—estimated by routing engine 205, as described above
t_{w}: estimated driver waiting time at the merchant premises in the case that a subject driver would reach merchant earlier than the time of completion of the food preparation—calculated, as described above, based on the formula:

t_{w}=max(0,t_{f}−t₁−t₂)
t_{d}: estimated food collection delay in the case where a subject driver would reach the merchant premises after completion of food preparation—calculated based on formulae of t_{d}=max(0, t₁+t₂−t_{f}), as described above.
t_{f}: estimated (remaining) food preparation time—provided by merchant or estimated based on historical data and real-time signal, as described above.
t₁: estimated time spent from current driver location (in-transit driver) to previous order drop-off location—estimated by routing engine 205, as described above.
t_{threshold}: a predefined time to distinguish orders having shorter and longer food preparation times, as described above.
α: the weightage of waiting time in merchant compared with pickup routing time (t₁ and t₂), as described above.
β: the weightage of delay time (driver reaches merchant after food is prepared) compared to pickup routing time (t₁ and t₂), as described above.

It is worth noting that, whilst a high t₂ will increase likelihood of a driver to ignoring/rejecting an order, high t₁ will not, because the driver is already on the way to complete the previous order

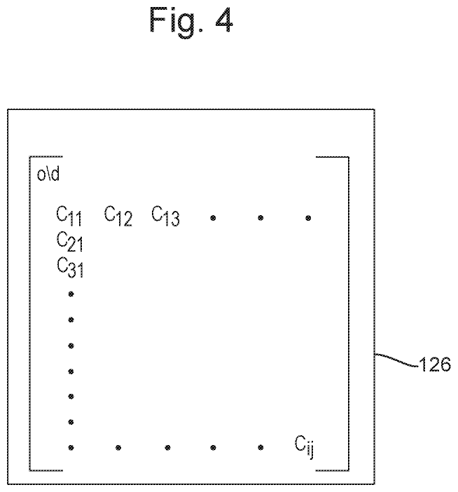

Referring back to FIG. 3 of the drawings, for each of a plurality of pending food delivery orders received, and the various values and parameters described above, the cost calculation processor 203 calculates the cost cᵢⱼ (at step 401) associated with each and every order-driver pair using the appropriate cost equation (according to whether the food preparation time for the subject order is deemed to be ‘high’ or ‘low’, and populates a database 126 configured in the form of the cost matrix defined above, as illustrated in FIG. 4 of the drawings.

For each order, once the cost calculation for a driver has been performed, a driver ID Dₙ is incremented by 1 (at step 402) and the process moves to the next driver to perform a cost calculation in respect of the next order-driver pair. Once the cost calculations for all of the order-driver pairs have been performed (Dₙ=Dⱼ at step 403), and the results stored in the database 126, each of the orders is allocated to the driver in respect of which the cost calculation is the lowest (step 404), and the resource allocation, thus completed, is output (at step 405). Dispatch communications are configured and output to the respective service provider communications devices, providing the respective drivers with details (D_{allocate}) of the respective food delivery order allocated to them. By using a linear assignment process, the method described above can continue, and be expanded, for all new orders received and is adaptable to accommodate the supply (available driver) distribution as it changes over time. As new drivers become available, new respective columns are added to the cost matrix and as new orders are received, new respective rows are added to the cost matrix stored in the database 126. Equally, as drivers become unavailable, the respective columns ‘drop out’ of the cost matrix and, as orders are assigned and completed, the respective rows ‘drop out’ of the cost matrix. The process is eminently scalable, and can be used to accommodate any number of orders and any number of available drivers in any number of specified regions at any one time. By distinguishing between high and low food preparation times, account can be taken of this highly variable parameter within the cost calculations, without undue processing burden, thereby enabling the resource allocation process to be performed in (near) real time, as orders are received and as the available driver pool changes over time.

### WORKED EXAMPLES

The following represent simplified worked examples, simply to illustrate the cost calculation and resource allocation principles described above. It will be appreciated that, in practice, there are likely to be a far larger number of pending orders and available drivers, and that these will be subject to constant change, as resources are allocated, new orders are received, orders are completed and drivers become available or not available.

### Example 1

There is one food order:
   O1, in which t_{f}=1200 secs
There are three driver candidates:
   D1, in which t₁=500 secs; t₂=300 secs; t_{w}=400 secs; t_{d}=0 secs
   D2, in which t₁=1000 secs; t₂=500 secs; t_{w}=0 secs; t_{d}=300 secs
   D3, in which t₁=0 secs; t₂=100 secs; t_{w}=1100 secs; t_{d}=0 secs
Assume:

$$α = 0.4 ; β = \frac{{t}_{f}}{{t}_{threshold}} ; {t}_{threshold} = 300 secs$$

Cost calculation for each driver-order pair based on cᵢⱼ=t₂+αt_{w}+βt_{d} formulae as t_{f}>t_{threshold}:

$$D 1 - O 1 : {c}_{11} = 300 + ( 0.4 ) ( 400 ) + \frac{1200}{300} ( 0 ) = 460$$

$$D 2 - O 1 : {c}_{21} = 500 + ( 0.4 ) ( 0 ) + \frac{1200}{300} ( 300 ) = 1700$$

$$D 3 - O 1 : {c}_{31} = 100 + ( 0.4 ) ( 1100 ) + \frac{1200}{300} ( 0 ) = 540$$

In this case, order O1 will be allocated to driver D1; as D1 has shorter waiting time than D3, and not causing any delay as for the case for D2.

### Example 2

There is one food order:
   O2, in which t_{f}=290 secs
There are two driver candidates:
   D4, in which t₁=200 secs; t₂=100 secs; t_{w}=0 secs; t_{d}=10 secs
   D5, in which t₁=0 secs; t₂=100 secs; t_{w}=190 secs; t_{d}=0 secs
Assume:

$$α = 0.4 ; β = \frac{{t}_{f}}{{t}_{threshold}} ; {t}_{threshold} = 300 secs$$

Cost calculation for each driver-order pair based on cᵢⱼ=t₁+t₂+αt_{w} formulae as t_{f}<=t_{threshold}:
   D4-O2: c₄₂=200+100+(0.4)(0)=300
   D5-O2: c₅₂=0+100+(0.4)(190)=176
As food preparation time is rather short in this case (t_{f}<=t_{threshold}), the logic will put more focus on finding nearest driver; which in this case driver D5.

It will be appreciated that the techniques described herein can be adapted for use in other shared economy services, including delivery of other (particularly time-sensitive) goods and documents. The described techniques can, potentially, be further adapted and extended for use in other resource allocation methods to reduced resource under-utilisation related to other shared economy services, wherein the service requests include at least one highly variable and largely unpredictable parameter that impacts significantly on the cost associated with each service request—available resource pair, to provide an efficient resource allocation solution that can be applied in substantially real time and is eminently saleable. Furthermore, because under-utilisation of resources can be reduced compared with known techniques by taking into account a key supply variable, the supply and demand distributions can be smoothed, thereby to avoid or at least mitigate issues associated with extreme discrepancies in supply-demand imbalance and potentially reducing both lag times (e.g. customer waiting times) and idle times (i.e. periods of time when an available resource is not being utilised or allocated to a service request) which are also technical effects applicable to, for example, electrical supply-load balancing or computer processing load balancing.

It will be appreciated that the invention has been described by way of example only. Various modifications may be made to the techniques described herein without departing from the spirit and scope of the appended claims. The disclosed techniques comprise techniques which may be provided in a stand-alone manner, or in combination with one another. Therefore, features described with respect to one technique may also be presented in combination with another technique.

1.-15. (canceled)

16. A communications server apparatus for allocating resources to service requests related to a shared economy on-demand service or asset provision, the communications server apparatus comprising a processor and a memory, and being configured, under the control of the processor, to execute instructions stored in the memory to:
receive a plurality of service requests, each service request comprising data representative of a service or asset requested and a delivery time at or by which said service or asset is required;
determine, in respect of each said service request, a lead time comprising a time period between a time at which a respective service request is received and the associated delivery time;
compare each said lead time with a predetermined threshold, and define each respective lead time as high if it is greater than the predetermined threshold and low if it is less than the predetermined threshold;
receive resource data comprising data representative of available resources capable of providing said service or asset, the available resources including service providers that are currently fulfilling a previous service request, and service providers that are not currently fulfilling a service request;
generate cost matrix data, each element of said cost matrix being representative of an available resource-service request pair, said cost matrix data assigning, in respect of each available resource-service request pair, a cost value; wherein said assigning a cost value in respect of each available resource-service pair comprises calculating, for each available resource-service request pair, the cost value, dependent on whether the lead time associated with the respective service request is high or low, wherein a first calculation is performed to calculate the cost value for an available resource-service request pair if the lead time associated with the respective service request is defined as high, and a second, different calculation is performed to calculate the cost value for an available resource-service request pair if the lead time associated with the respective service request is defined as low;
for each service request, select, from a respective set of available resource-service request pair cost values, a minimum cost value and assign the available resource associated with the selected cost value to the respective service request.

17. A communications server apparatus according to claim 16, configured for the generation of said cost matrix to comprise applying a linear assignment algorithm to data derived from said service requests and said resource data.

18. A communications server apparatus according to claim 16, configured for only said first calculation to use a parameter representative of service or asset delivery delay time if a respective available resource cannot provide the service or asset by the delivery time specified in the respective service request.

19. A communications server apparatus according to claim 18, configured for said delivery delay time to be weighted according to an estimated time period within which a respective available resource will be able to provide the respective service or asset.

20. A communications server apparatus according to claim 16, configured for said first and second calculations to use a parameter representative of a lag time if a respective available resource is able to provide a respective service or asset earlier than the specified delivery time.

21. A communications server apparatus according to claim 20, configured for said lag time to be weighted according to an estimated time period within which a respective available resource will be able to provide the respective specified service or asset.

22. A communications server apparatus according to claim 16, configured for said first calculation to comprise a sum of a time value representative of a time period within which a respective available resource will be able to provide the respective specified service or asset, a weighted lag time if the respective available resource is able to provide the service or asset earlier than the delivery time specified in the respective service request, and a weighted delivery delay time if a respective available resource cannot provide the service or asset associated with the respective user request by the specified delivery time; and for the second calculation to comprise a sum of a time value representative of a time period within which a respective available resource will be able to provide the respective specified service or asset and a weighted lag time if the respective available resource is able to provide the service or asset earlier than the delivery time specified in the respective service request.

23. A communications server apparatus according to claim 16, for allocating resources to service requests related to a product delivery service, configured for each said service request to represent a request by a service user for a delivery vehicle to transport a product from a product merchant location specified in said service request to an end user and to comprise data representative of a product delivery order and a collection time at which said product will be ready for collection from the product merchant location by the delivery vehicle; and for said lead time to comprise a time period between t time at which a respective service request is received and the associated collection time, and for said resource data to comprise data representative of available delivery vehicles and their current geographical location.

24. A communications server apparatus according to claim 23, configured for said product delivery service to comprise a food delivery service.

25. A communications server apparatus according to claim 23, comprising a routing engine for estimating, in respect of each available delivery vehicle resource, a time period within which a respective delivery vehicle can travel to the product merchant location specified in a service request at which a product for delivery is to be collected.

26. A method, performed in a communications server apparatus, for allocating resources to service requests related to a shared economy on-demand service or asset provision, the method comprising, under control of a processor of the communications server apparatus:
receiving a plurality of service requests, each service request comprising data representative of a service or asset requested and a delivery time at or by which said service or asset is required;
determining, in respect of each said service request, a lead time comprising a time period between a time at which a respective service request is received and the associated delivery time;
comparing each said lead time with a predetermined threshold, and define each respective lead time as high if it is greater than the predetermined threshold and low if it is less than the predetermined threshold;
receiving resource data comprising data representative of available resources capable of providing said service or asset, the available resources including service providers that are currently fulfilling a previous service request, and service providers that are not currently fulfilling a service request;
generating cost matrix data, each element of said cost matrix being representative of an available resource-service request pair, said cost matrix data assigning, in respect of each available resource-service request pair, a cost value; wherein said assigning a cost value in respect of each available resource-service pair comprises calculating, for each available resource-service request pair, the cost value, dependent on whether the lead time associated with the respective service request is high or low, wherein a first calculation is performed to calculate the cost value for an available resource-service request pair if the lead time associated with the respective service request is defined as high, and a second, different calculation is performed to calculate the cost value for an available resource-service request pair if the lead time associated with the respective service request is defined as low;
for each service request, selecting, from a respective set of available resource-service request pair cost values, a minimum cost value and assign the available resource associated with the selected cost value to the respective service request.

27. A non-transitory storage medium storing instructions which, when executed by a processor of a communications server apparatus, cause the processor to perform a method for allocating resources to service requests related to a shared economy on-demand service or asset provision, the method comprising, under control of a processor of the communications server apparatus:
receiving a plurality of service requests, each service request comprising data representative of a service or asset requested and a delivery time at or by which said service or asset is required;
determining, in respect of each said service request, a lead time comprising a time period between a time at which a respective service request is received and the associated delivery time;
comparing each said lead time with a predetermined threshold, and define each respective lead time as high if it is greater than the predetermined threshold and low if it is less than the predetermined threshold;
receiving resource data comprising data representative of available resources capable of providing said service or asset, the available resources including service providers that are currently fulfilling a previous service request, and service providers that are not currently fulfilling a service request;
generating cost matrix data, each element of said cost matrix being representative of an available resource-service request pair, said cost matrix data assigning, in respect of each available resource-service request pair, a cost value; wherein said assigning a cost value in respect of each available resource-service pair comprises calculating, for each available resource-service request pair, the cost value, dependent on whether the lead time associated with the respective service request is high or low, wherein a first calculation is performed to calculate the cost value for an available resource-service request pair if the lead time associated with the respective service request is defined as high, and a second, different calculation is performed to calculate the cost value for an available resource-service request pair if the lead time associated with the respective service request is defined as low;
for each service request, selecting, from a respective set of available resource-service request pair cost values, a minimum cost value and assign the available resource associated with the selected cost value to the respective service request.

28. A communications system for allocating resources to service requests related to a shared economy on-demand service or asset provision, the communications system comprising at least one user communications device and communications network equipment operable for the communications server apparatus and the at least one user communications device to establish communication with each other therethrough, and at least one service or asset provider communications device and communications network equipment operable for the communications server apparatus and the at least one service provider communications device to establish communication with each other therethrough, the communications server apparatus comprising a processor and a memory, and being configured, under the control of the processor, to execute instructions stored in the memory to:
receive a plurality of service requests, each service request comprising data representative of a service or asset requested and a delivery time at or by which said service or asset is required;
determine, in respect of each said service request, a lead time comprising a time period between a time at which a respective service request is received and the associated delivery time;
compare each said lead time with a predetermined threshold, and define each respective lead time as high if it is greater than the predetermined threshold and low if it is less than the predetermined threshold;
receive resource data comprising data representative of available resources capable of providing said service or asset, the available resources including service providers that are currently fulfilling a previous service request, and service providers that are not currently fulfilling a service request;
generate cost matrix data, each element of said cost matrix being representative of an available resource-service request pair, said cost matrix data assigning, in respect of each available resource-service request pair, a cost value; wherein said assigning a cost value in respect of each available resource-service request pair comprises calculating, for each available resource-service request pair, the cost value, dependent on whether the lead time associated with the respective service request is high or low, wherein a first calculation is performed to calculate the cost value for an available resource-service request pair if the lead time associated with the respective service request is defined as high, and a second, different calculation is performed to calculate the cost value for an available resource-service request pair if the lead time associated with the respective service request is defined as low;
for each service request, select, from a respective set of available resource-service request pair cost values, a minimum cost value and assign the available resource associated with the selected cost value to the respective service request.
